(19) United States
(12) Patent Application Publication
(10) Pub. No.: US 2016/0212483 A1
(43) Pub. Date: Jul. 21, 2016

(54) HYBRID PROGRAM CHANGE FOR IP-ENABLED MULTIMEDIA DEVICES

(71) Applicant: ARRIS Enterprises, Inc., Suwanee, GA (US)

(72) Inventor: Carol J. Ansley, Johns Creek, GA (US)

(21) Appl. No.: 14/601,329

(22) Filed: Jan. 21, 2015

(51) Int. Cl. H04N 21/462; H04N 21/854; H04N 21/845; H04N 21/438; H04N 21/2343; H04N 21/239; H04N 21/426; H04N 21/643; H04N 21/2665

(52) U.S. Cl. CPC H04N 21/4622; H04N 21/64322; H04N 21/85406; H04N 21/8456; H04N 21/2665; H04N 21/234309; H04N 21/2393; H04N 21/4263; H04N 21/4384

(57) ABSTRACT

Methods, systems, and apparatuses can be operable to facilitate program change operations on a multimedia device that can access both QAM video delivery and IP video delivery. A multimedia device can request content from multiple sources, choosing the first available source for a requesting media player. The multimedia device can shift from an IP unicast source to a QAM broadcast source seamlessly when both are available.

### TECHNICAL FIELD

This disclosure relates to facilitating program change operations on multimedia devices that have access to QAM services and IP services.

### BACKGROUND

Multiple services operators (MSO) use community access television (CATV) network infrastructure for carrying Motion Picture Experts Group (MPEG) video signals and Internet protocol (IP) data signals, among other types. Originally all MPEG digital video content was carried within broadcast Quadrature Amplitude Modulated signals (QAMs). MSOs have begun to also offer some video content over unicast IP data signals. A continuing issue for video services has been the time delay from the selection of a video program until its display on the desired display device. It is desirable to provide a method that reduces the potential delay experienced by a user after the selection of a video program.

### BRIEF DESCRIPTION OF THE DRAWINGS

FIG. 1 is a block diagram illustrating an example system operable to facilitate reduced program change times.

FIG. 2 is a block diagram illustrating an example multimedia device operable to facilitate reduced program change times.

FIG. 3 is a block diagram illustrating an example media player operable to facilitate reduced program change times.

FIG. 4 is a flowchart illustrating an example process operable to facilitate reduced program change times.

FIG. 5 is a component diagram illustrating an example multimedia device operable to facilitate reduced program change times.

Like reference numbers and designations in the various drawings indicate like elements.

### DETAILED DESCRIPTION

In various embodiments, systems and methods disclosed herein can operate to facilitate reduced channel change times for user-initiated program changes. A variety of technical developments have led to increased time for program change operations as perceived by end users. Many MSOs have changed their video transmissions from analog video to digital video carried over QAM signals. For a multimedia device, such as a set top box, to retrieve video content from a QAM signal, a multistage process is used. The multistage process for retrieving video content from a QAM signal includes the multimedia device tuning to the correct QAM signal, then navigating the MPEG protocol to find the correct video and audio streams within the QAM. After finding the correct streams, the device waits until the beginning of a group of pictures to begin decoding the video signal. Once the device has begun decoding the video signal, the device fills a buffer to a sufficient level before beginning to provide video information to the display device to prevent any later delays from resulting in a loss of video on the display. The amount of time for which a user waits to receive video is dependent on the amount of time it takes for the multimedia device to complete each step of the above multistage process.

Technology to deliver video over IP protocols is also being installed in video delivery networks. Using broadband IP networks to deliver video can reduce the amount of time used to access a new program because the program content can be sent at many times the normal playout speed. But video over IP delivery is often restricted to unicast delivery of video programs which can result in prohibitive amounts of network bandwidth consumption during peak usage periods. In various embodiments, systems and methods of this disclosure can operate to improve the slow process of digital video program changes.

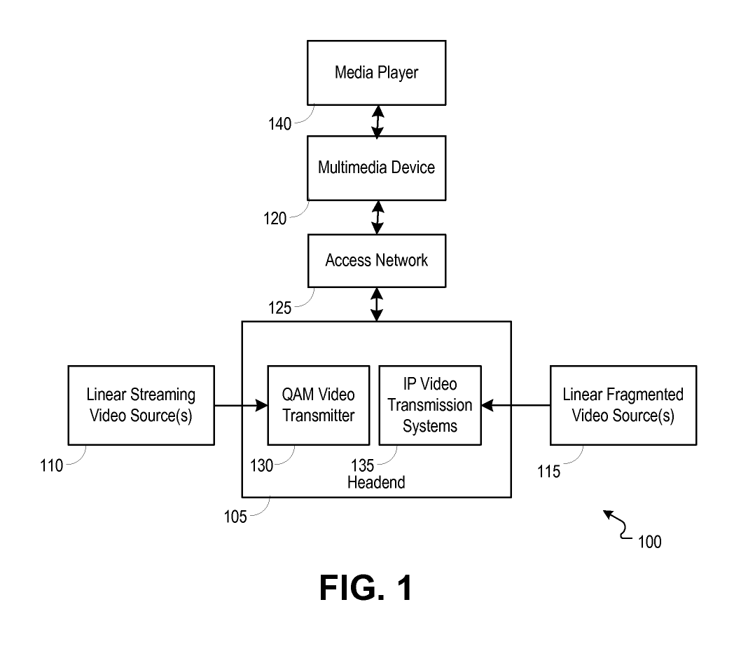

FIG. 1 is a block diagram illustrating an example system 100 operable to facilitate reduced program change times. In embodiments, a headend 105 can provide video service(s) (e.g., video content received by a headend 105 from one or more linear streaming video sources 110 or one or more fragmented linear video sources 115) to one or more multimedia devices 120 in one or more subscriber groups (e.g., service group(s)). Video services may be delivered from the headend 105 to a multimedia device 120 through an access network 125.

In some embodiments, a headend 105 can deliver live television programming (e.g., media streaming in real time from a television channel) to one or more multimedia devices 120 using either QAM Video Transmitters 130 or IP Video Transmission Systems 135. The multimedia device can provide video programming to at least one media player 140. In embodiments, live television can include playback of a record buffer associated with a buffered television channel, pay-per view channels, and other types of content delivered from a headend 105 to one or more media players 140. In embodiments, a headend 105 can deliver live television to one or more media players 140 using a fragmented linear video delivery in real time from a television channel.

In embodiments, a customer may access a live television stream with a traditional set top box comprising a multimedia device 120 accessing QAM video streams transmitted by a QAM modulator in the headend 105 for an embedded media player 140 that in turn passes the video content to a television set. In embodiments, a customer may access a live television stream with an IP video set top box comprising a multimedia device 120 accessing fragmented video delivered over IP from a CMTS in the headend 105 for an embedded media player 140 that in turn passes the video content to the television set. In embodiments, other broadband access networks, such as fiber to the home, may utilize other equipment to deliver fragmented IP video. It should be understood that other multimedia devices, such as a DSL gateway, may receive QAM video streams or fragmented video streams.

It should be understood that fragmented video sources are generally not constrained by the bit rate of the video stream. A fragment of a video stream may be sent at any rate supported by the fragmented video source and the IP interface. In contrast, linear streaming video sources are generally constrained to the bit rate of the video stream.

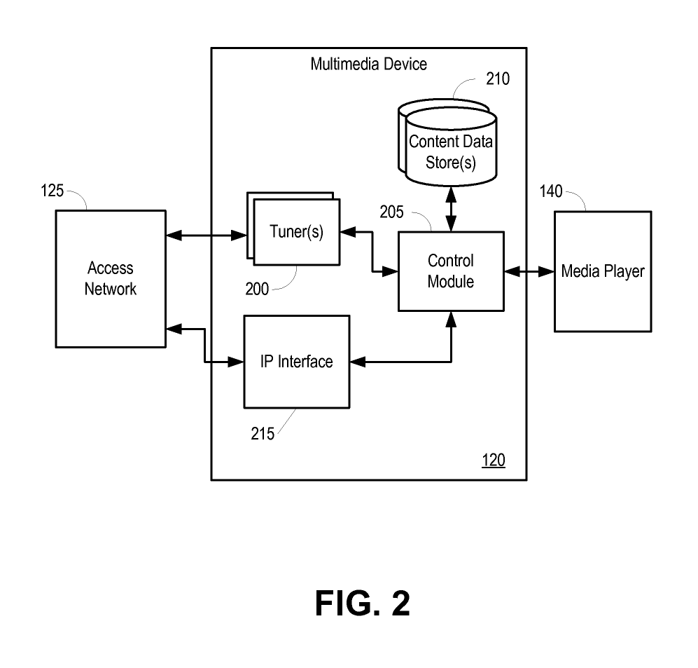

FIG. 2 is a block diagram illustrating an example multimedia device 120 operable to facilitate reduced program change times. In embodiments, a multimedia device 120 can include one or more tuners 200, a control module 205 (e.g., a processor), one or more content data stores 210, and an IP interface 215.

In embodiments, linear video content from one or more streaming video source(s) 110 of FIG. 1 can be received through one or more tuner(s) 200 via an interface with a network 125 to a headend 105 of FIG. 1. As an example, where the multimedia device 120 has more than one tuner 200, a customer can view content from a first channel on a media player 140 connected to the multimedia device 120 while the multimedia device 120 records content from a plurality of other channels. As another example, where the multimedia device 120 has more than one tuner, the device can record content from a number of channels equal to the number of tuners in the device. It should be understood that a tuner 200 may be a single device used to capture information related to a channel or program, or the tuner 200 may be a broadband capture device with a demodulator that acts on a portion of the spectrum.

In embodiments, linear fragmented content from one or more linear fragmented video source(s) 115 of FIG. 1 can be received through an IP interface 215 via an interface with a network 125 from a headend 105 of FIG. 1. As an example, where the multimedia device 120 has an embedded data over cable service interface specification (DOCSIS) cable modem to receive IP video data, a customer can view content from a first channel on a media player 140 connected to the multimedia device 120 while the multimedia device records content from a plurality of fragmented video sources 115 of FIG. 1. As another example, where the multimedia device 120 has enough bandwidth on its IP interface 215, the device can take content from a number of fragmented video sources. It should be understood that the IP interface may be an embedded DOCSIS cable modem, a fiber optical network terminal (ONT) or other broadband access entity. For example, for a multimedia device attached to a CATV hybrid fiber coaxial (HFC) network, a data over cable service interface specification (DOCSIS) cable modem is appropriate while for a multimedia device attached to a passive optical fiber network, an ONT is appropriate. Other implementations using other broadband access networks may use other methods to extract the relevant channel or program information from an IP network.

In embodiments, a control module 205 can receive video content from the one or more tuners 200 or an IP interface 215. In embodiments, the control module 205 can instruct the one or more tuners 200 to tune to a specific channel. For example, the control module 205 can instruct a tuner 200 to tune to a channel designated for live viewing by a customer. As another example, the control module 205 can request the linear fragmented video source 115 of FIG. 1 to begin providing video for a program designated for recording by a customer. In embodiments, the control module 205 can forward content from either source to a data store. For example, when a user designates a program for recording or pauses a channel, the control module 205 can forward content associated with the program to one or more content data stores 210. In embodiments, upon receiving video content, the control module 205 can forward the content to one or more media players. For example, when a customer requests to view recorded content or live television, the control module 205 can forward content received from a tuner 200 to a media player 140.

In embodiments, a control module 205 can receive video content from an IP interface 215. The control module 205 can convert the fragmented video stream to a traditional Motion Picture Experts Group (MPEG) transport stream for communicating with a media player 140. In embodiments, the control module 205 can relate a video fragment with a program timestamp to a linear streaming program timestamp.

In embodiments, when a control module 205 receives a request to change programs or to initiate a new viewing session, the control module can determine if the new program is available via QAM delivery, IP delivery or both. In embodiments, the control module 205 may consider if the requested program is already available to the control module because of a previous request or if this is the first request for the program. In embodiments, the control module 205 can switch between program streams delivered by QAM or IP as it decides to forward content to a media player 140. For example, digital video is encoded in segments called Group of Pictures (GoP). The control module 205 may elect to stream data from a GoP delivered over the IP interface to a media player 140 until the tuner 200 can provide the next GoP in time for the media player's consumption. In embodiments, the control module 205 may request at least one fragment from the fragmented video source 115 of FIG. 1 that can be delivered faster than real time, to allow the control module 205 to provide video content to the media player 140 sooner than it would be available from the tuner 200.

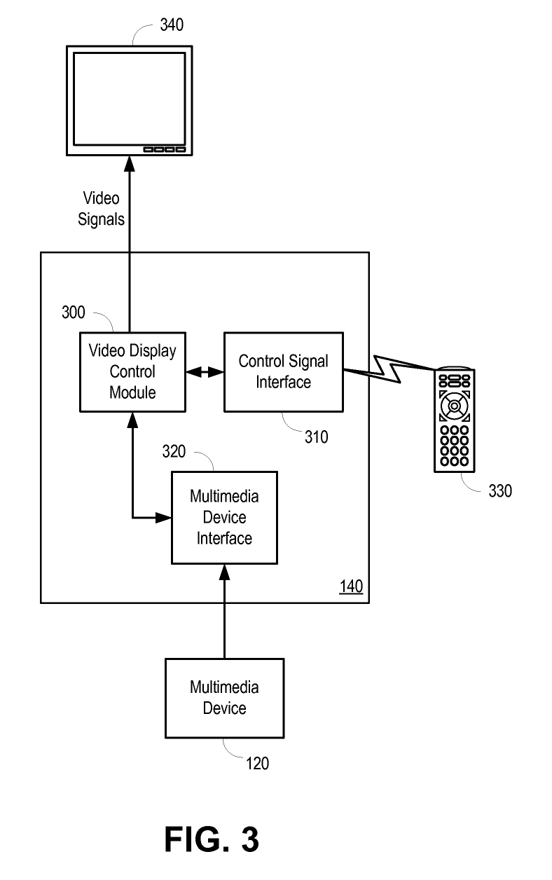

FIG. 3 is a block diagram illustrating an example dependent media player 140 operable to facilitate reduced program change times. In embodiments, a media player 140 can include, a video display control module 300 (e.g., a processor), a control signal interface 310, and a multimedia device interface 320.

In embodiments, control signals can be communicated from a remote control device 330 to a control signal interface 310. The control signals can operate to provide requests from a customer to the video display control module 300 which can communicate with the multimedia device 120 using the multimedia device interface 320. The control module 205 of FIG. 2 can act based upon the requests received through the control signal interface 310. For example, a customer can use a remote control device 330 to communicate tuning designations (e.g., channel to tune to, channel to record, etc.) to the control module via the control signal interface. In embodiments, the video display control module 300 can forward video content received from a multimedia device 120 to a display device 340.

In embodiments, a subscriber can initiate channel or program selection using the remote control 330. For example, when a subscriber requests a program change, that request is passed through the control signal interface to the video display control module. The video display control module communicates with the control module in the multimedia device 120 through the multimedia device interface. Within the multimedia device 120, the control module may initiate two parallel processes, requesting one or more fragments of the requested program from the linear fragmented video source as well as directing a tuner to access the requested channel. A subscriber will see the requested program begin when the re-formatted fragment reaches the media player 140. The subscriber's video feed can switch seamlessly to the tuner version when the tuning process has completed.

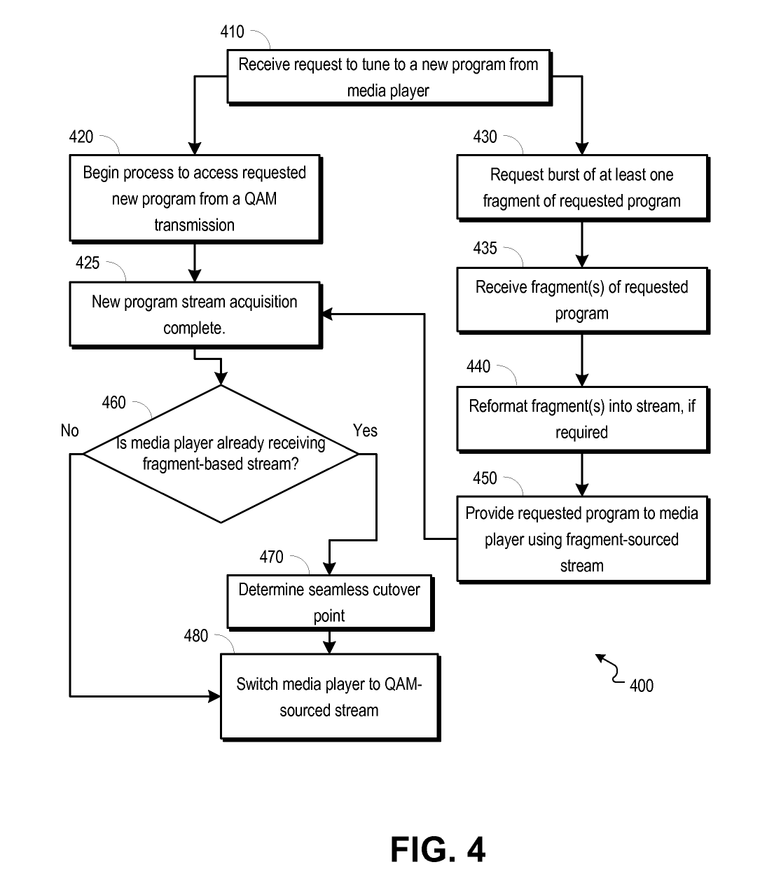

FIG. 4 is a flowchart illustrating an example process 400 operable to facilitate reduced program change times. The process 400 can start when a user selects a program on a first multimedia player. In embodiments, the user can select a live television program to view on a media player. In embodiments, the media player can comprise any one of a set top box, a tablet, a laptop computer, or similar devices.

At 410, the multimedia device can receive a request to tune to a new program from a user and initiate both a QAM tuning process as well as requesting at least one fragment from the new program. For example, the user can use an input device (e.g., remote control 330 of FIG. 3) associated with a media player 140 of FIG. 1 to select a new program from an electronic program guide presented by the media player. The media player can communicate that request to a multimedia device (e.g., multimedia device 120 of FIG. 1). In embodiments, the new program might have been selected by the user for an automatic recording. For example, the user can request that all episodes of a program be recorded, leading the multimedia device to act on a previously stored request for a recording.

At 420, the multimedia device can begin the process to retrieve the requested program from a QAM transmission. It will be appreciated by those skilled in the relevant art that the process for retrieving the requested program from a QAM transmission may include various steps. The multimedia device may use narrow band tuners, wideband tuners or full band capture tuners as well as other circuitry that is part of the process for tuning to a QAM video channel to access the video program material. For example, a tuner/demodulator system can gain QAM lock, then MPEG packet synchronization. After that point, the MPEG transport stream may be recovered and the MPEG table data may be analyzed to identify the particular program elementary streams.

At 425, the multimedia device completes the tuning process and has an MPEG stream available for use.

At 430, the multimedia device requests one or more fragments that represent video of the requested program. Various IP protocols may be used to request fragments within a fragmented video stream. In embodiments, the multimedia device may use any protocol that can provide specific fragments of a specific program upon request. The one or more fragments can be requested via an IP interface (e.g., IP interface 215 of FIG. 2) responsive to instructions provided by a control module.

At 435, the multimedia device receives the requested fragment(s) through an IP connection from a linear fragmented video source (e.g., linear fragmented video source 115 of FIG. 1). In embodiments, the IP connection to the multimedia device can include an embedded cable modem that communicates with a CMTS in a headend. In embodiments, the IP connection to the multimedia device can comprise an Optical Network Termination unit, communicating with the multimedia device locally, connected to an Optical Line Termination in the headend or central office.

At 440, the multimedia device may reformat the fragments into an MPEG transport stream, mimicking the format that a program is delivered in from a QAM transmission. A media player may be able to receive program information in any one or more of a variety of formats, or it may be limited to receiving program information in MPEG transport streams.

At 450, the multimedia device can provide the requested program to the requesting media player. In embodiments, the multimedia device may be a gateway and the media player may be an IP set top box. Alternatively, the multimedia device and the media player may both be components within a single set top box.

At 460, the determination may be made whether step 450 has been executed and the media player is using the fragment-sourced program content. The determination whether step 450 has been executed and the media player is using the fragment-sourced program content may be made, for example, by the multimedia device. If the multimedia device's IP interface connects to a broadband access network, the process steps of 430 through 450 are generally faster than the process steps of 420 through 425. If step 450 has completed successfully before step 425, then the process continues to step 470. If step 425 has completed before step 450, then the process continues to step 480.

At 470, the multimedia device determines an appropriate cutover point from the fragment-based stream of step 450 to the QAM-based stream of step 425. In embodiments, the seamless switchover can be between GoPs, or coordinated in a variety of other ways.

At 480, the multimedia device switches the media player to the QAM-sourced stream. Switching the media player to the QAM-sourced stream can be facilitated utilizing the seamless cutover point determined in step 470. If step 460 determined the media player was not receiving the requested program stream, then the step of switching will be simplified to directing the requested QAM-based program stream to the media player.

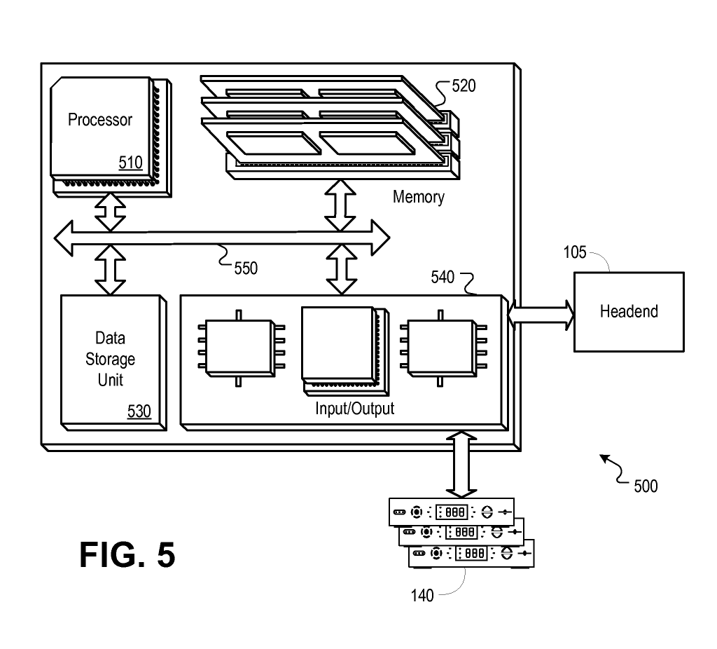

FIG. 5 is a component diagram of an example device 500 operable to facilitate pausing playback of recorded or live television on a multimedia player and resuming playback from the pause point on the same or a different multimedia player. The device 500 can include a processor 510, a memory 520, a storage device 530, and an input/output device 540. Each of the components 510, 520, 530, and 540 can, for example, be interconnected using a system bus 550. The processor 510 can be capable of processing instructions for execution within the device 500. In one implementation, the processor 510 can be a single-threaded processor. In another implementation, the processor 510 can be a multi-threaded processor. The processor 510 can be capable of processing instructions stored in the memory 520 or on the storage device 530.

The memory 520 can store information within the hardware configuration of the device 500. In one implementation, the memory 520 can be a computer-readable medium. In one implementation, the memory 520 can be a volatile memory unit. In another implementation, the memory 520 can be a non-volatile memory unit.

In embodiments, the storage device 530 can be capable of providing mass storage for the device 500. In one implementation, the storage device 530 can be a computer-readable medium. In various different implementations, the storage device 530 can, for example, include a hard disk device, an optical disk device, flash memory or some other large capacity storage device. In embodiments, the storage device 530 can be a DVR or PVR.

The input/output device 540 can provide input/output operations for the device 500. In embodiments, the input/output device can include driver devices configured to receive input data from and send output data to a media player 140. In embodiments, the input/output device can include driver devices configured to receive input data from and send output data to a headend 105. In another implementation, the input/output device can include driver devices configured to receive input data from and send output data to a plurality of dependent set-top boxes or multimedia players 140.

Those skilled in the art will appreciate that the invention improves user experience when changing programs or beginning a new viewing session. Moreover, the invention improves the flexibility of the video delivery system by allowing multiple video delivery mechanisms to be advantageously utilized.

The methods, systems, and apparatuses described in this disclosure enable more rapid program change than a simple digital QAM set top box can achieve alone. Moreover, the subject matter of this disclosure enables efficient use of the continuing presence of QAM transmission of popular video programming. In embodiments, a multimedia device, such as a gateway, may utilize multiple transmission methods to provide rapid channel change performance to connected media players, such as IP set top boxes. Further, in embodiments, a single device can include a multimedia device as well as a media player and utilize this method of rapid program change.

The subject matter of this disclosure, and components thereof, can be realized by instructions that upon execution cause one or more processing devices to carry out the processes and functions described above. Such instructions can, for example, comprise interpreted instructions, such as script instructions, e.g., JavaScript or ECMAScript instructions, or executable code, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer readable medium. The computer readable medium can be a machine readable storage device, a machine readable storage substrate, a memory device, or a combination of one or more of them.

The term “system processor” encompasses all apparatus, devices, and machines for processing data, including by way of example a programmable processor, a computer, or multiple processors or computers. The system processor can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The elements of a computer typically include a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile communications device, a telephone, a cable modem, a set-top box, a mobile audio or video player, or a game console, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with a user, embodiments of the subject matter described in this specification can be operable to interface with a computing device having a display, e.g., a CRT (cathode ray tube) or LCD (liquid crystal display) monitor, for displaying information to the user and a keyboard and a pointing device, e.g., a mouse or a trackball, by which the user can provide input to the computer. In embodiments, a remote control (e.g., a device using infrared or radio frequency signals) can be used to provide for interaction with a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In embodiments, multitasking and parallel processing may be advantageous.

What is claimed is:

1. A method comprising:
receiving a request for multimedia content;
requesting one or more fragments associated with the multimedia content initiating a process to receive the multimedia content through a QAM transmission; and
providing the multimedia content using the one or more fragments at least until the process to receive the multimedia content through the QAM transmission is complete.

2. The method of claim 1 further comprising:
formatting the multimedia content of the one or more fragments to comply with a continuous streaming format.

3. The method of claim 1 wherein:
the multimedia content is provided over an internet protocol connection from a multimedia content server.

4. The method of claim 1, further comprising:
completing the process of receiving the multimedia content through the QAM transmission;
determining a seamless cutover point between the content as received through the QAM transmission and the content as provided through the one or more fragments; and
switching the program stream source from the one or more fragments to the QAM transmission based at least in part on the seamless cutover determination.

5. The method of claim 4 wherein determining a seamless cutover point comprises:
determining a ending timestamp for the current group of pictures playing from fragmented content;
determining starting timestamps for each group of pictures received from the QAM transmission; and,
selecting a seamless cutover point when said ending timestamp is within a set time limit of a starting timestamp.

6. An apparatus, comprising:
one or more tuners configured to receive continuous streaming content from one or more QAM channels;
one or more interfaces configured to communicate with at least one multimedia server and to receive fragmented multimedia content;
a processor configured to:
control the one or more tuners,
request one or more fragments associated with the multimedia content, and
reformat fragments associated with the multimedia content into a continuous streaming format;
one or more interfaces configured to be used to:
receive a user request for multimedia content, and
output the requested multimedia content to a media player, wherein the content is taken from the one or more fragments; and
storage configured to buffer multimedia content from the one or more tuners at least until a seamless cutover is made from the fragmented content to the continuous streaming content.

7. The method of claim 6 wherein the processor is further configured to:
request the one or more fragments from a multimedia content server over an internet protocol connection.

8. The method of claim 6, the processor further configured to:
determine a seamless cutover point between the content as received through the QAM transmission and the content as provided through the one or more fragments; and
switch the program stream source from the one or more fragments to the QAM transmission based at least in part on the seamless cutover determination.

9. The method of claim 8 wherein the processor determining a seamless cutover point comprises:
determining a ending timestamp for the current group of pictures playing from fragmented content;
determining starting timestamps for each group of pictures received from the QAM transmission; and,
selecting a seamless cutover point when said ending timestamp is within a set time limit of a starting timestamp.

10. One or more computer readable media having instructions operable to cause one or more processors to perform the operations comprising:
receiving a request to provide multimedia content comprising a first program;
identifying a first tuner that can access said first program;
directing said first tuner to access said first program;
identifying a video server that can provide at least a portion of said first program over an IP interface;
requesting from said video server at least a portion of said first program; and
outputting the said first program as requested from whichever source can first supply the content.

11. The one or more computer-readable media of claim 10, having instructions further operable to cause the one or more processors to perform the operations comprising:
formatting the video content received over an IP interface into a continuous streaming format.

12. The one or more computer-readable media of claim 10, having instructions further operable to cause the one or more processors to perform the operations comprising:
causing the video output to seamlessly transition from the IP video source to the tuner source if the IP video source was the first source to provide the desired content.
